(19) United States
(12) Patent Application Publication
(10) Pub. No.: US 2019/0039267 A1
(43) Pub. Date: Feb. 7, 2019

(54) MOLD FOR FORMING THREE-DIMENSIONAL EMBOSSMENTS ON A SURFACE OF A SHOE PART AND THE MANUFACTURING METHOD THEREOF

(71) Applicant: ORISOL ASIA LTD., Chang Hwa (CN)

(72) Inventors: Jakov MAKOVER, Maccabim (IL); Bar Cochva MARDIX, Tel Aviv (IL); Yaacov SADEH, Rechovot (IL)

(21) Appl. No.: 16/158,278

(22) Filed: Oct. 11, 2018

Related U.S. Application Data
(63) Continuation-in-part of application No. PCT/CN2016/091694, filed on Jul. 26, 2016.

(51) Int. Cl. B29C 33/38; B29C 33/42; B29C 35/08; B29D 35/12

(52) U.S. Cl. CPC B29C 33/3857; B29C 33/424; B29C 2035/0827; B29D 35/126; B29D 35/128; B29C 35/0805

(57) ABSTRACT

A method for manufacturing a mold for forming three-dimensional embossments on a surface of a shoe part, comprising: making a high-resolution template with a texture structure; using the high-resolution template to make a high-resolution pattern mold, forming a boundary wall inside the mold through the texture structure; defining, by the boundary wall, different regions provided for being filled with polyurethane compositions of different colors.

### BACKGROUND OF THE INVENTION

### Field of Invention

A method for manufacturing a mold, and more particularly a method for manufacturing a mold for forming three-dimensional embossments on a surface of a shoe part.

A mold, and more particularly a mold for forming three-dimensional embossments on a surface of a shoe part.

### Related Art

The upper part of a shoe is made of base materials such as leather, mesh, fabric or other materials with reinforcement or special mechanical properties or colors or decoration. Generally, the shoe upper part has a thickness of 0.2 mm-4 mm. The production and installation technology of this shoe part began with leather cutting and splicing procedures a hundred years ago. The glue bonding technology developed in the past 25 years has been introduced into the shoe market. Among them, there are two kinds of bonding techniques: (1) glue solution, and (2) a hot melt layer activated by a high temperature produced on a surface of a shoe upper part; however, both techniques must use pre-cut pieces and then carry out embossing technique. The so-called embossing technique uses a mold for thermal or high frequency induction heating to produce a pattern, in which the stitching and heating by a heat press and subsequent embossing procedures require a large amount of time, labor power and energy consumption, and cannot be produced on the same production line.

### SUMMARY OF THE INVENTION

The present invention relates to a method for manufacturing a mold for forming three-dimensional embossments on a surface of a shoe part. Through the above-mentioned mold, it is possible to manufacture a finely textured upper layer on an outer surface of a shoe in a low cost, multi-colored, automated manner. The materials used in the footwear industry are a spectrum of, for example, artificial leather, perforated substrates, finely textured substrates, etc. These materials can be replaced by polyurethanes directly attached on the shoe by a casting procedure. A grain size of the texture can range from a few microns to a few millimeters. The primary objective of the invention is to provide a method for manufacturing a mold capable of producing a fine upper layer in a low cost, multi-color, and automatic manner.

The procedure comprises following steps of:

A. making a high-resolution template;

B. making a high-resolution pattern mold;

A. Making a high-resolution template:

The template making process is based on the plate-making technique of a photopolymer printing plate or a direct engraving method to form an appropriate image resolution, and the process is extremely dependent on the technical quality.

Among them, photopolymer printing plates are widely used in the printing industry. Among the famous manufacturers are, for example, DuPont, Flint, MacDermid, Toyobo, Toray, Sumitomo Riko, Kodak, etc. The thickness of a photopolymer printing plate is generally from 0.3 to 12 mm, and can be selected according to the thickness requirement of a pattern. Please refer to FIGS. 1-1 to 1-3 in which the manufacturing procedures of the photopolymer printing plate are shown, which comprise: after ultraviolet light is irradiated through a mold masking element 50, parts of a photopolymer 60 which have not been irradiated with the ultraviolet light are washed away, and then a step of drying at 60° C. completes the plate making procedures.

Please refer to FIG. 2 in which the structure of the mold masking element 50 is shown, which is a thin film alternately disposed with transparent sections 52 and opaque sections 51. The above-mentioned mold masking element 50 is produced with laser ablation (Esco, FlexoLaser), analog film (Fujifilm Co., Ltd.), Digiflex, and Kodak technologies with a resolution up to 5,000 lpi. Areas of the PP plate (i.e., the aforementioned photopolymer 60) corresponding to the transparent sections 52, are cured due to ultraviolet irradiation, while areas of the PP plate (i.e., the aforementioned photopolymer 60) corresponding to the opaque sections 51 remain uncured. The PP plate (i.e., the aforementioned photopolymer 60) is then subjected to a washing process whereby the uncured photopolymer 60 is removed. The aforementioned photopolymer 60 printing plate can be washed by water and solvents.

During the washing process, water washing, solvent washing, and photopolymeric melting steps are each carried out separately. A shape of a template 70 formed is the portion left after the uncured photopolymer 60 is washed away. Therefore, the shape of the template 70 is determined by parameters set for ultraviolet exposure and the mold masking element 50. While a texture of the template 70 is determined by the mold masking element 50. It is worth mentioning that a thickness range of the aforementioned template 70 is between 0.43 and 6 mm.

High resolution textures can only be formed on a surface of the template 70. The three-dimensional structure of the template 70 is made by irradiating the photopolymer 60 with ultraviolet light penetrating through the two-dimensional mold masking element 50. As shown on the left side of FIG. 7, defining the opaque section 51 on the mold masking element 50 to be called a black line 511. A depth of a texture detail 71 has a correlation with a linear size (width) of the black line 511 of the mold masking element 50 relatively. For specific description, please refer to FIG. 7, which can be demonstrated by different thicknesses (dₗᵢₙₑ) formed by the black lines 511 and the transparent sections 52.

In FIG. 7, an embossment produces a depth varying from ˜2×dₗᵢₙₑ to ˜0.1×dₗᵢₙₑ, depending on a degree of exposure of UV irradiation. High UV exposure results in a relatively low embossment depth D. Low UV exposure results in a relatively deep embossment depth D.

Therefore, the embossment depth D depends on a detailed configuration size on the mold masking element 50 and an overall degree of exposure. Each printing plate of the photopolymer 60 has a different sensitivity to ultraviolet light irradiation respectively. Eventually, the embossment depth D depends on a photosensitivity of the printing plate of the photopolymer 60, the degree of exposure and the structure of the mold masking element 50. The embossment depth D is directly proportional to the detailed configuration size of the texture on the mold masking element 50.

Direct engraving technique can be used to create the surface texture of a pattern. In this method, a 3D pattern is engraved on a plate by using laser ablation according to a programming and has a resolution up to 2100 lpi. Direct engraving materials and engraving machines are produced by Stork, SPG, Kodak, Hell and other related companies.

Dissimilar chemical etching steps are very useful for the fabrication of a template. In this method, a protective coating is formed on a partial region of the template to be etched for performing a subsequent etching operation, and the etched material is selected from photopolymers that are polymerizable by UV radiation. Firstly, the surface of a printing plate is coated with a uniform layer of unexposed polymer. At present, there are two exposure techniques for photopolymers, one of which is to expose a predetermined exposure region by means of the mold masking element 50 (as shown in FIG. 2), and the second of which is to expose by high resolution UV laser light (Lusher).

B. making a high-resolution pattern mold:

After the selective irradiation contact procedure, the photopolymer template 70 after being exposed through the masking with the mold masking element 50, or the directly engraved template 70, is used in the preparation for a following mold 80 (as shown in FIG. 8). A material of the mold 80 being used has high release property and high removal property to avoid the use of spray, and the use of spray will block the texture detail 71 and also lower the quality, so that it is particularly important for high-quality texture reproduction.

Any grades of castable silicone rubber can be used as the mold 80 material with high release performance. Castable silicone polymers are produced by companies such as DOW, Wacker, KDL, and Polytek. The castable silicones have different mixing viscosities, and required casting time and mechanical properties are different. The composition of the castable silicones can contain mineral fillers to enhance its performance. The production of the mold 80 utilizes conventional casting procedures of pouring a silicone compound onto the template 70 and then vacuuming (as shown in FIG. 8).

When demolding time is reached, the mold 80 is separated from the template 70.

A second type of the mold 80 is produced by using molten polymers. These polymers can be polypropylenes, polyethylenes, polybutylene terephthalates and the like. The molten polymers are poured onto the template 70, then vacuumed and cooled, and the cooled plastic mold 80 is separated from the template 70.

The mold 80 produced is filled with a polyurethane composition comprising a polyisocyanate, a polyol, an organic pigment, a pigment dispersant, a polymerization catalyst, an UV absorbent, an anti-yellowing additive, and a surfactant. And the use of polyurethane chemistry in this method is based on the technique of common liquid two-component polyurethanes. Suppliers of polyurethane parts are German Bayer, BASF, Polytek, etc. The polyurethane surfactant is responsible for wetting surfaces of the mold 80.

The polymer material of the mold 80 with a low surface tension, such as silicones and polyolefin polymers (for example, polypropylenes, polyethylenes), requires a polyurethane composition with an extremely low surface tension, wherein the surface tension of the polyurethane composition should be less than 30 dynes/cm, preferably less than 25 dynes/cm. Further, reduction in the surface tension of the polyurethane composition is achieved by using a surfactant, wherein the surfactant comprises the following types: BYK348, BYK349, BUK307, Capstone FC-51, Capstone FC-50, Dabco DC193, Dabco 5598, Dabco LK-221, and the like.

It is worth mentioning that the mold 80 forms a corresponding texture according to the texture detail 71 of the template 70, and a size the corresponding texture is determined by the texture detail 71. When the corresponding texture are enlarged to a certain extent, then the corresponding texture becomes a boundary wall 81.

The method for manufacturing a mold for forming three-dimensional embossments on a surface of a shoe part has been disclosed above.

Furthermore, the mold 80 is provided for being filled with the multi-colored polyurethane composition, the multi-colored polyurethane composition needs to be prevented from diffusion and material migration between the compositions through an isolation mechanism. The prevention mechanism can be achieved by the boundary wall 81 of the mold 80, and the boundary wall 81 is formed through the black lines 511 on the mold masking element 50.

As shown in FIG. 9, after exposing by a predetermined light source, the black lines 511 on the mold masking element 50 will produce the texture details 71 on a flexo plate (i.e., the aforementioned template 70). Therefore, as shown in FIG. 9, for the formation of the boundary wall 81 in the mold 80, a thickness of the black line 511, a sensitivity of the printing plate, and a degree of exposure will affect a thickness and a height of the aforementioned boundary wall 81. The wider a line diameter of the black line 511 will result in the higher boundary wall 81, and the higher the degree of exposure will result in a decrease in the height of the boundary wall 81.

As shown in FIG. 10, different regions limited by the boundary walls 81 of the mold 80 are filled with polyurethane compositions 91, 92 of different colors.

According to the above, through the above-described process of making a high-resolution template and making a high-resolution pattern mold, it is possible to produce a mold 80 having a boundary wall 81, the boundary wall 81 defines different regions for filling with polyurethane compositions 91, 92 of different colors, which in turn, facilitates the subsequent process to provide a method for manufacturing a mold capable of producing a fine upper layer in a low cost, multi-color, and automatic manner.

Furthermore, the present invention relates to A mold for forming three-dimensional embossments on a surface of a shoe part, comprising:

a mold body made by a template with a texture structure, the mold body includes at least one corresponding texture defined by the texture structure, the mold body is made by a two-component composition of silicones or polymers with high release properties.

### BRIEF DESCRIPTION OF THE DRAWINGS

FIGS. 1-1˜1-3 show a development sequence of a photopolymer plate;

FIG. 2 is a schematic illustration of transparent and opaque sections of a mold masking element;

FIG. 3 is a schematic illustration of the production of a template by using the mold masking element;

FIG. 4 is a schematic illustration of a photopolymers curing process carried out according to the transparent sections of the mold masking element;

FIG. 5 is a schematic illustration showing texture patterns of the photopolymer plate after curing;

FIG. 6 is a schematic illustration of the partially cured photopolymer plate after a washing process;

FIG. 7 is a schematic illustration showing the reduction of textured embossment depths of a photopolymer printing plate caused by thicknesses of black lines and degrees of exposure;

FIG. 8 is a schematic illustration of procedures of filling a mold material into upper patterns and demolding of a finished mold;

FIG. 9 is a schematic illustration of boundary walls generated by the black lines of the mask;

FIG. 10 is a schematic illustration showing the effects generated by the difference between different heights of the two boundary walls and a height of outer walls, and the contact with the polyurethane materials inside and outside of the boundary walls, and the height of the boundary walls will be equal to that of the embossment of the plate after separating the polyurethane materials;

FIG. 11 is an illustration of an image used for production of a pattern.

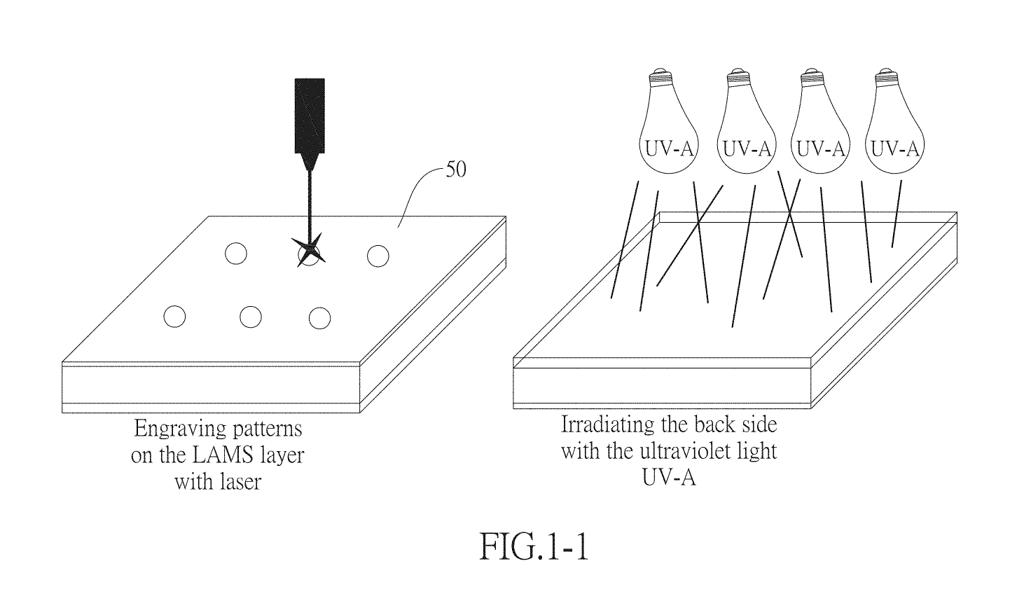

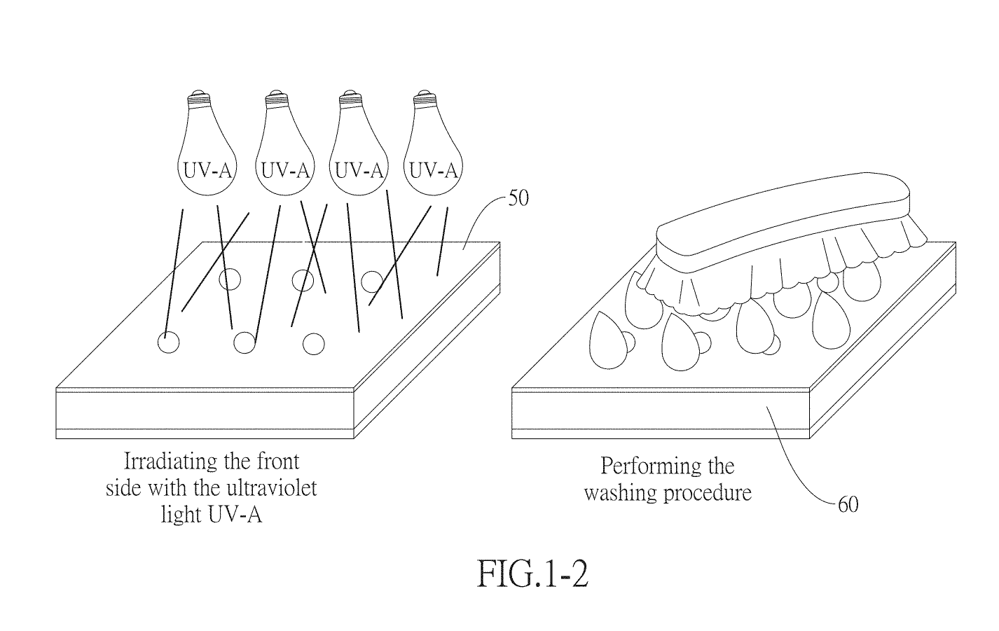

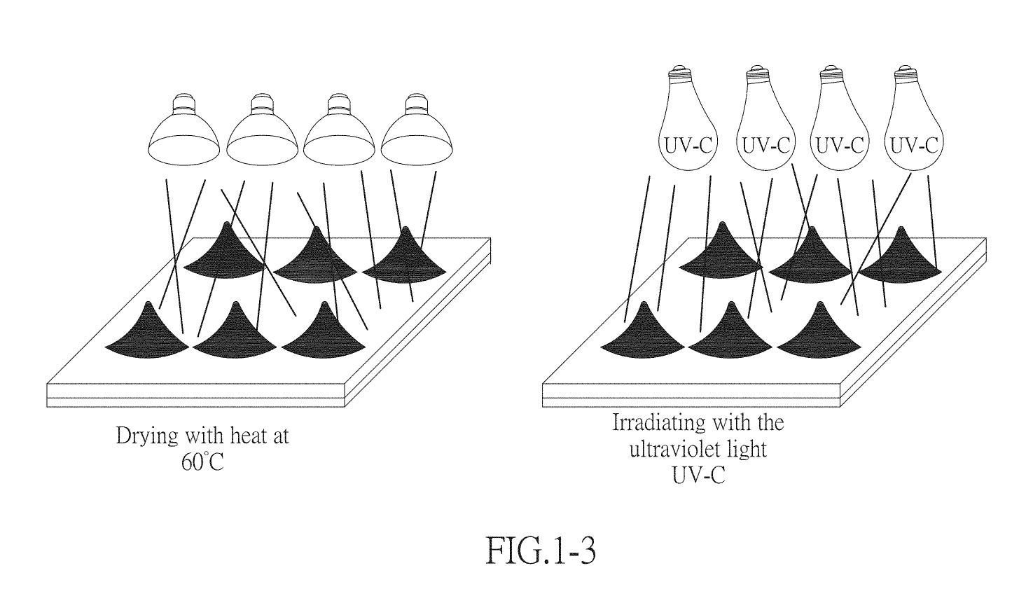

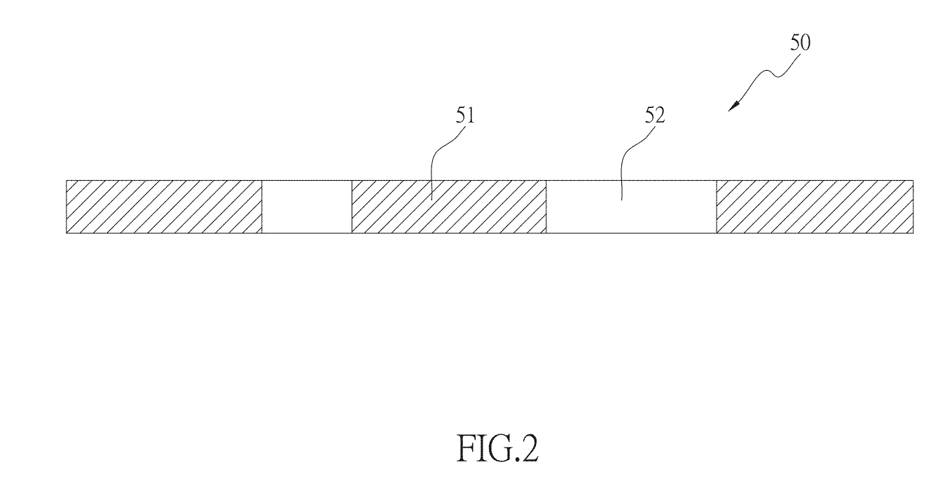

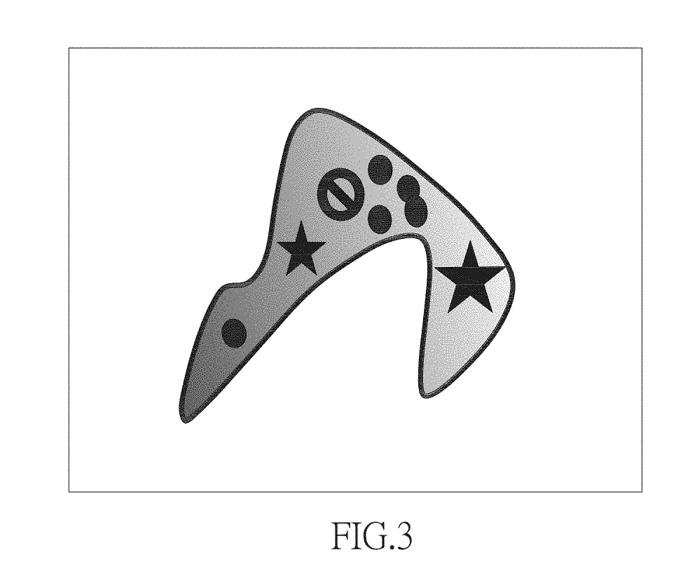

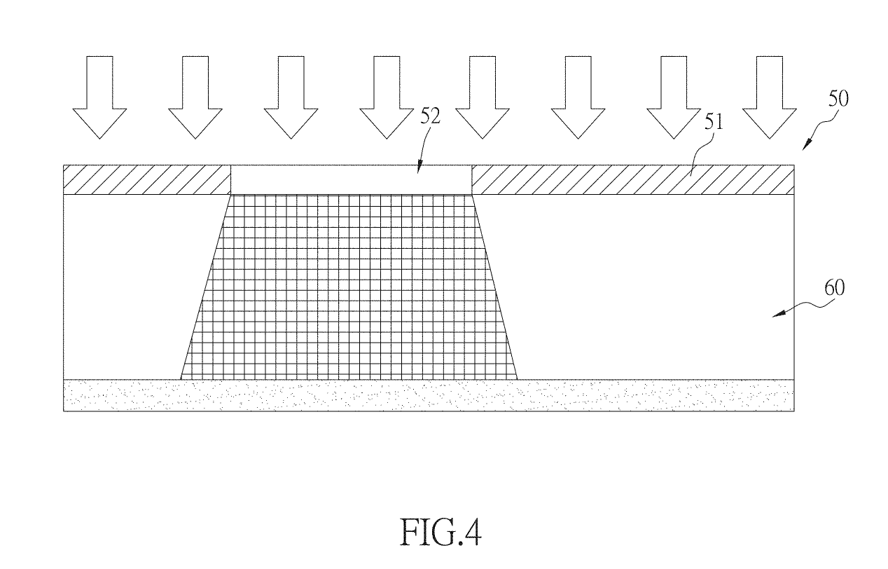

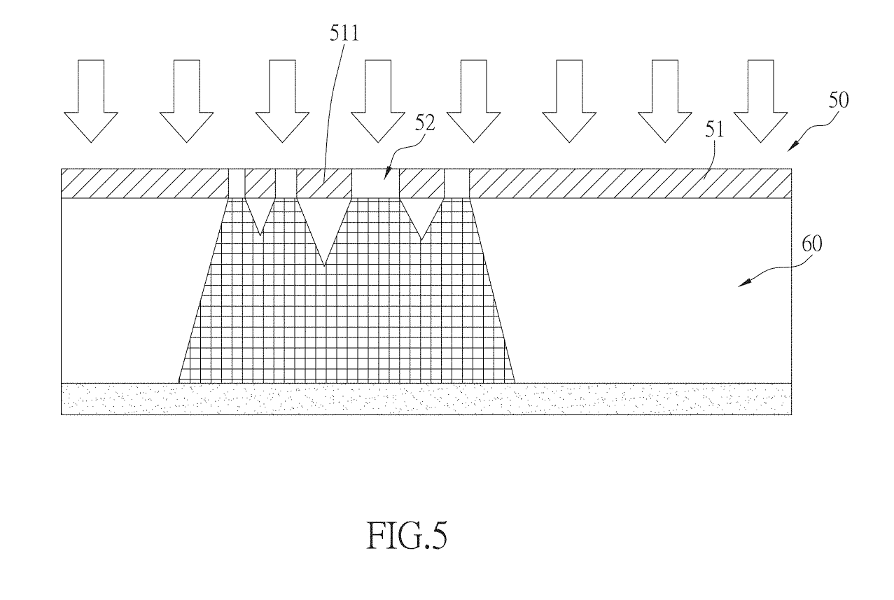

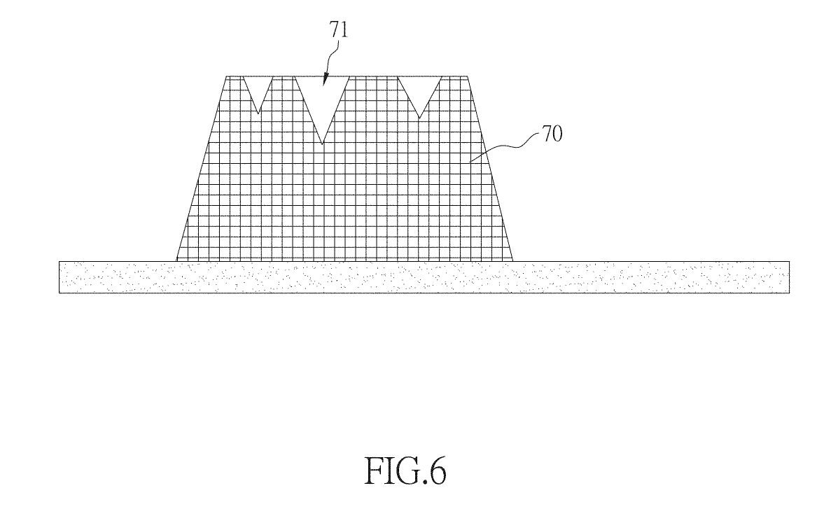

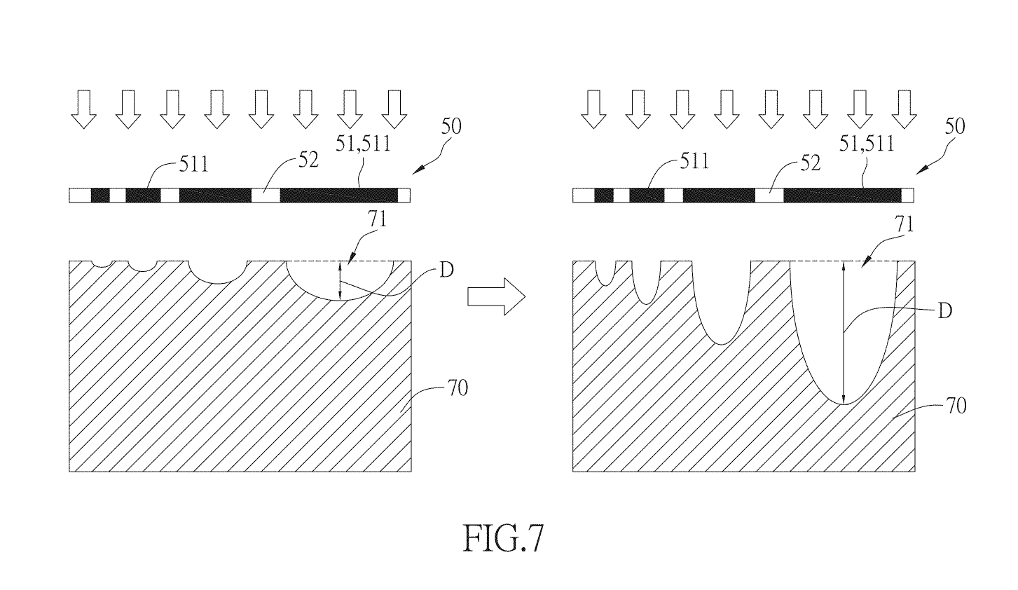

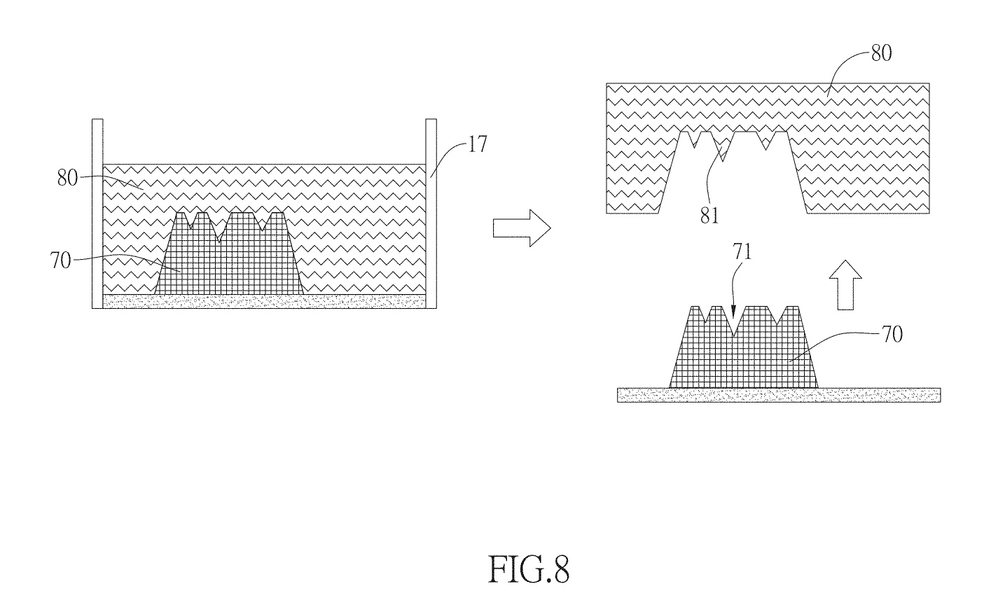

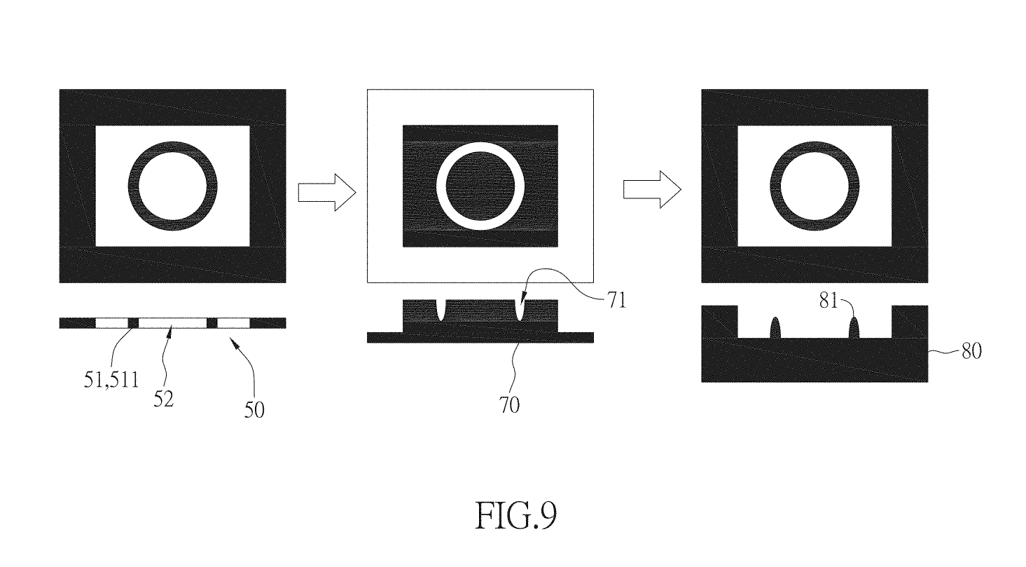

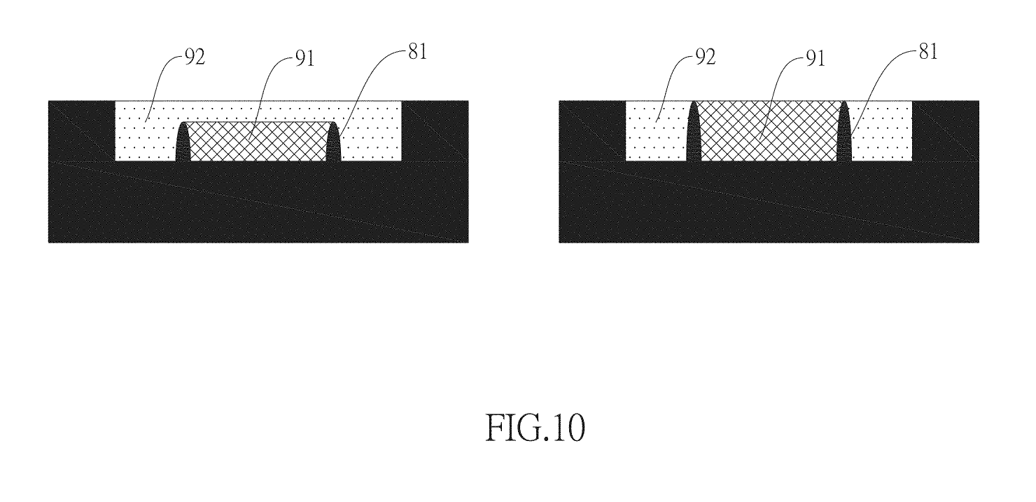

### DETAILED DESCRIPTION OF THE INVENTION

The foregoing and other technical contents, features and effects of the present invention will be clearly presented in the following detailed description of the preferred embodiments with reference to the drawings.

### Specific Embodiment 1

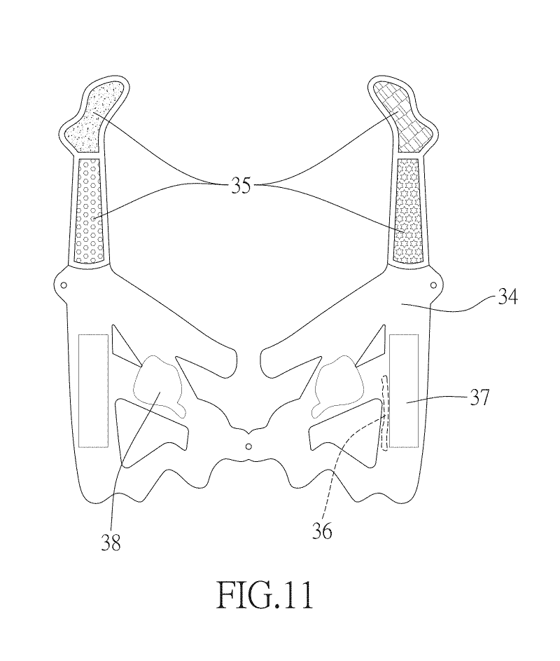

FIG. 11 shows an image 34 with a 10% simple circular screen at a resolution of 150 lpi (lines per inch), which comprises four types of textures 35, hollow negative letters 36, six positive letters 37 with each of the letters surrounded by a 0.2 mm white line, and grayscale graphics 38. Among them, the negative objects are imaged on a flexographic printing plate (actual product model: 1.7 mm DuPont Cyrel DSP67) by a laser (actual product model: ESCO CDI Spark 4835).

A main plate is exposed by an exposure unit of the model DuPont Cyrel 1000 for 20 minutes. A back plate does not need to be exposed. The flexographic printing plate is used as a template for producing a silicone mold after the development processing (processing conditions: photosensitive resin 1000P, processor washed with a solvent). A boundary wall with a width of 0.2 mm and a height of 0.3 mm is produced around the white line. A castable silicone two-component rubber (actual product model: Polytek TinSil 70-60) is mixed and poured onto the flexographic printing plate. A mold is formed after the castable silicone two-component rubber has been cured for approximately 20 hours, and the mold is separated from the flexographic printed plate.

The letters limited by the boundary walls are filled with various colored liquid two-component polyurethane pigments (actual product model: DuraElast 80) from Evermore Chemical: yellow, orange, red, black, brown and pink. The coloring procedure is accomplished by adding a polyhydric alcohol based paste composition with a component amount of 5% of the pigments. There are several points worth noting, in which the PU composition is uniformly spread outward from the boundary walls. The entire mold is then filled with the same composition colored with a cyan pigment. The procedure for all the filling processes is done by a PU injection molding machine (actual product model: Saip SD1). The mold is mounted on an X-Y stepping axial table (actual product model: SXYxC manufactured by Yamaha Motor Co., Ltd.), and the displacement direction and displacement amount are controlled during the filling process according to the procedure.

The parameter setting of filling rate is 3 g/sec. The filled mold is heated in an oven at 70° C. for 5 minutes. Then, the polyurethane composition is attached to an object under a pressure of 1 kg/cm2 (the actual product model of the aforementioned object is: polyester mesh HF SD2120P, GME). After 30 minutes, the reticulated cured polyurethane composition is taken out from the mold. The permeability of the polyurethanes provides good adhesion to the mesh. All textures are identical to the textures of the template. A normal thickness of the polyurethane portion is 1.5 mm A negative 10% screen, 150 pins per inch, 50 microns deep. The tip of the pin is 20 microns. Employing a 2 mm detailed texture results in a 1 mm deep embossment. Hollow negative (white parts) 14 pt letters produce negative letters with a depth of 0.5 mm on the polyurethanes.

### Specific Embodiment 2

The differences between the implementation objects described herein and that of the specific embodiment 1 lie in: the white lines surrounding each of the positive letters is 1 mm instead of 0.2 mm. The negative objects are imaged by a laser (actual product model: ESCO CDI Spark 4835) on a flexographic printing plate (actual product model: 1.7 mm DuPont Cyrel DSP67). The exposure of the printing plate is complete in 20 minutes (the actual product model is: DuPont Cyrel 1000 exposure unit), and there is no need for exposing the back plate. The flexographic printing plate is used as a template for the silicone mold production after the development processing (photosensitive resin 1000P and treatment procedure of washing with a solvent). A boundary wall with a width of 1 mm and a height of 0.8 mm is produced by the white line surrounding each of the positive letters.

A castable silicone two-component rubber (Polytek TinSil 70-60) is mixed and poured onto the flexographic printing plate. A mold is formed after the silicone rubber has been cured for approximately 20 hours, and the mold is separated from the flexographic printed plate.

The letters limited by the boundary walls are filled with various colored liquid two-component polyurethane pigments (actual product model: DuraElast 80) from Evermore Chemical: yellow, orange, red, black, brown and pink. The coloring procedure is accomplished by adding a polyhydric alcohol paste with a component amount of 5% of the pigments, and the polyurethane composition did not uniformly spread outward from the boundary walls.

The entire mold is then filled with the same composition colored with a cyan pigment. The procedure of all the filling processes is done by a polyurethane injection molding machine (actual product model: Saip SD1). The mold is mounted on an X-Y stepping axial table (actual product model: SXYxC manufactured by Yamaha Motor Co., Ltd.), and the displacement direction and displacement amount are controlled during the filling process according to the procedure.

The parameter setting of filling rate is 3 g/sec. The filled mold is heated in an oven at 70° C. for 5 minutes. Then, the polyurethane composition is attached to an object under a pressure of 1 kg/cm2 (the actual product model of the aforementioned object is: polyester mesh HF SD2120P, GME).

After 30 minutes, the reticulated cured polyurethane composition is taken out from the mold. The permeability of the polyurethanes provides good adhesion to the mesh. All textures are identical to the textures of the template. A normal thickness of the polyurethane portion is 1.5 mm. A negative 10% screen, 150 pins per inch, 50 microns deep. The tip of the pin is 20 microns. Employing a 2 mm detailed texture results in a 1 mm deep embossment. Hollow negative (white parts) 14 pt letters produce negative letters with a depth of 0.5 mm on the polyurethanes.

### Specific Embodiment 3

The differences between the implementation objects described herein and that of the specific embodiment 2 lie in: a screen is produced with a resolution of 22.5 lpi. The negative objects are imaged on a flexographic printing plate (actual product model: MacDermid digital MAF 3.96 mm) by a laser (actual product model: ESCO CDI Spark 4835). The main plate is exposed by an exposure unit of the model DuPont Cyrel 1000, which is complete in 25 minutes, and the exposure of the back plate takes 1 minute.

The flexographic printing plate is used as a template for producing a silicone mold after the development processing (processing conditions: photosensitive resin 1000P, processor washed with a solvent). A boundary wall with a width of 1 mm and a height of 0.8 mm is produced around the white line. A castable silicone two-component rubber (actual product model: Polytek TinSil 70-60) is mixed and poured onto the flexographic printing plate. A mold is formed after the castable silicone two-component rubber has been cured for approximately 20 hours, and the mold is separated from the flexographic printed plate.

The letters limited by the boundary walls are filled with various colored liquid two-component polyurethane pigments (actual product model: DuraElast 80) from Evermore Chemical: yellow, orange, red, black, brown and pink. The coloring procedure is accomplished by adding a polyhydric alcohol paste with a component amount of 5% of the pigments.

The entire mold is then filled with the same composition colored with a cyan pigment. The procedure of all the filling processes is done by a polyurethane injection molding machine (actual product model: Saip SD1). The mold is mounted on an X-Y stepping axial table (actual product model: SXYxC manufactured by Yamaha Motor Co., Ltd.), and moved during the filling process according to the procedure.

The parameter setting of filling rate is 3 g/sec. The filled mold is heated in an oven at 70° C. for 5 minutes. Then, the polyurethane composition is attached to an object under a pressure of 1 kg/cm2 (the actual product model of the aforementioned object is: polyester mesh HF SD2120P, GME).

After 30 minutes, the reticulated cured polyurethane composition is taken out from the mold. The permeability of the polyurethanes provides good adhesion to the mesh. All textures are identical to the textures of the template. A normal thickness of the polyurethane portion is 3 mm. A negative 10% screen, 150 pins per inch, and 100 microns deep. The tip of the pin is 20 microns. Employing a 2 mm detailed texture results in a 2 mm deep embossment. Hollow negative (white parts) 14pt letters produce negative letters with a depth of 0.8 mm on the polyurethanes.

### Specific Embodiment 4

Using the mesh plate described in embodiment 2, the mold masking element is imaged on a Fujifilm negative film by a Kodak Flexcel NX System. A metal type letterpress plate (actual product model: Toray WS73HII) is exposed with the film under vacuum. The plate is exposed by an exposure unit of the model DuPont Cyrel 1000 for 2 minutes. The flexographic printing plate is used as a template for the silicone mold production after the development processing (AQF Dantex plus treatment procedure of washing with water). A boundary wall with a width of 1 mm and a height of 0.6 mm is produced by the white line surrounding each of the positive letters.

A castable silicone two-component rubber (Polytek TinSil 70-60) is mixed and poured onto the flexographic printing plate. A mold is formed after the silicone rubber has been cured for approximately 20 hours, and the mold is separated from the flexographic printed plate.

The letters limited by the boundary walls are filled with various colored liquid two-component polyurethane pigments (actual product model: DuraElast 80) from Evermore Chemical: yellow, orange, red, black, brown and pink. The coloring procedure is accomplished by adding a polyhydric alcohol paste with a component amount of 5% of the pigments. The entire mold is then filled with the same composition colored with a cyan pigment.

The procedure of all the filling processes is done by a polyurethane injection molding machine (actual product model: Saip SD1). The mold is mounted on an X-Y stepping axial table (actual product model: SXYxC manufactured by Yamaha Motor Co., Ltd.), and moved during the filling process according to the procedure.

The parameter setting of filling rate is 3 g/sec. The filled mold is heated in an oven at 70° C. for 5 minutes. Then, the polyurethane composition is attached to an object under a pressure of 1 kg/cm2 (the actual product model of the aforementioned object is: polyester mesh HF SD2120P, GME).

After 30 minutes, the reticulated cured polyurethane composition is taken out from the mold. The permeability of the polyurethanes provides good adhesion to the mesh resulting in all textures being identical to the textures of the template. A normal thickness of the polyurethane portion is 0.6 mm. Employing a 2 mm detailed texture results in a 0.6 mm deep embossment. Hollow negative (white parts) 14pt letters produce negative letters with a depth of 0.4 mm on the polyurethanes, and the colored positive letters are spaced apart from each other by 1 mm of the cyan polyurethane composition.

### Specific Embodiment 5

Using the mesh plate described in embodiment 2, the mold masking element is imaged on a flexographic printing plate (actual product model: 1.7 mm DuPont Cyrel DSP67) by a laser (actual product model: ESCO CDI Spark 4835). The printing plate is exposed by an exposure unit of the model DuPont Cyrel 1000 for 20 minutes. The back plate does not need to be exposed.

The flexographic printing plate is used as a template for producing a silicone mold after the development processing (processing conditions: photosensitive resin 1000P, processor washed with a solvent). A boundary wall with a width of 1 mm and a height of 0.8 mm is produced around the white line. Polyethylenes (actual product model: Ipethene 4203 manufactured by Cannel Olefins Ltd.) are heated to 140° C. and poured onto the letterpress plate. The plate with the melted polyethylenes is kept at 150° C. for 10 minutes under vacuum. The plate and polyethylenes are then cooled to room temperature, and the polyethylene mold is separated from the letterpress plate.

The letters limited by the boundary walls are filled with various colored liquid two-component polyurethane pigments (actual product model: DuraElast 80) from Evermore Chemical: yellow, orange, red, black, brown and pink. The coloring procedure is accomplished by adding a polyhydric alcohol paste with a component amount of 5% of the pigments, and the polyurethane composition did not uniformly spread outward from the boundary walls.

The entire mold is then filled with the same composition colored with a cyan pigment. The procedure of all the filling processes is done by a polyurethane injection molding machine (actual product model: Saip SD1). The mold is mounted on an X-Y stepping axial table (actual product model: SXYxC manufactured by Yamaha Motor Co., Ltd.), and the displacement direction and displacement amount are controlled during the filling process according to the procedure.

The parameter setting of filling rate is 3 g/sec. The filled mold is heated in an oven at 70° C. for 5 minutes. Then, the polyurethane composition is attached to an object under a pressure of 1 kg/cm2 (the actual product model of the aforementioned object is: polyester mesh HF SD2120P, GME).

After 30 minutes, the reticulated cured polyurethane composition is taken out from the mold. The permeability of the polyurethanes provides good adhesion to the mesh. All textures are identical to the textures of the template. A normal thickness of the polyurethane portion is 0.6 mm. A negative 10% screen, 150 pins per inch, 50 microns deep. The tip of the pin is 20 microns. Employing a 2 mm detailed texture results in a 0.6 mm deep embossment. Hollow negative (white parts) 14pt letters produce negative letters with a depth of 0.4 mm on the polyurethanes.

### Specific Embodiment 6

Using the mesh plate described in embodiment 2, the mold masking element is imaged on a Fujifilm negative film by a Kodak Flexcel NX System. A metal type letterpress plate (actual product model: Toray WS73HII) is exposed with the film under vacuum. The plate is exposed by an exposure unit of the model DuPont Cyrel 1000 for 2 minutes. The flexographic printing plate is used as a template for the silicone mold production after the development processing (AQF Dantex plus treatment procedure of washing with water). A boundary wall with a width of 1 mm and a height of 0.6 mm is produced around the white line.

A castable silicone two-component rubber (Polytek TinSil 70-60) is mixed and poured onto the flexographic printing plate. A mold is formed after the silicone rubber has been cured for approximately 20 hours, and the mold is separated from the flexographic printed plate.

The letters limited by the boundary walls are filled with various colored liquid two-component polyurethane pigments (actual product model: DuraElast 80) from Evermore Chemical: yellow, orange, red, black, brown and pink. The coloring procedure is accomplished by adding a polyhydric alcohol paste with a component amount of 5% of the pigments. The entire mold is then filled with the same composition colored with a cyan pigment.

The procedure of all the filling processes is done by a polyurethane injection molding machine (actual product model: Saip SD1). The mold is mounted on an X-Y stepping axial table (actual product model: SXYxC manufactured by Yamaha Motor Co., Ltd.), and moved during the filling process according to the procedure.

The parameter setting of filling rate is 3 g/sec. The filled mold is heated in an oven at 70° C. for 5 minutes. Then, the polyurethane composition is attached to an object under a pressure of 1 kg/cm2 (the actual product model of the aforementioned object is: polyester mesh HF SD2120P, GME).

After 30 minutes, the reticulated cured polyurethane composition is taken out from the mold. The permeability of the polyurethanes provides good adhesion to the mesh. All textures are identical to the textures of the template. A normal thickness of the polyurethane portion is 0.6 mm Employing a 2 mm detailed texture results in a 0.6 mm deep embossment. Hollow negative (white parts) 14pt letters produce negative letters with a depth of 0.5 mm on the polyurethanes, and the colored positive letters are spaced apart from each other by 1 mm of the cyan polyurethane composition.

In summary, the above embodiments and drawings are merely the preferred embodiments of the present invention, and the scope of implementation of the present invention is not limited thereto. In other words, all the equivalent changes and modifications made according to the appended claims shall still fall within the scope covered by the appended claims of the present invention.

What is claimed is:

1. A method for manufacturing a mold for forming three-dimensional embossments on a surface of a shoe part, comprising:
making a template with a texture structure;
filling a casting material into the template to make a mold, and forming a corresponding texture inside the mold through the texture structure.

2. The method for manufacturing the mold for forming three-dimensional embossments on the surface of the shoe part as claimed in claim 1, wherein the corresponding texture is a boundary wall, the boundary wall inside the mold is configured to define different regions.

3. The method for manufacturing the mold for forming three-dimensional embossments on the surface of the shoe part as claimed in claim 1, wherein the texture structure on the template is made by irradiating ultraviolet light through a mold masking element.

4. The method for manufacturing the mold for forming three-dimensional embossments on the surface of the shoe part as claimed in claim 1, wherein the texture structure on the template is made by a direct engraving technique.

5. The method for manufacturing the mold for forming three-dimensional embossments on the surface of the shoe part as claimed in claim 1, wherein the casting material of the mold is a two-component composition of silicones.

6. The method for manufacturing the mold for forming three-dimensional embossments on the surface of the shoe part as claimed in claim 2, wherein the casting material of the mold is a two-component composition of silicones.

7. The method for manufacturing the mold for forming three-dimensional embossments on the surface of the shoe part as claimed in claim 3, wherein the casting material of the mold is a two-component composition of silicones.

8. The method for manufacturing the mold for forming three-dimensional embossments on the surface of the shoe part as claimed in claim 4, wherein the casting material of the mold is a two-component composition of silicones.

9. The method for manufacturing the mold for forming three-dimensional embossments on the surface of the shoe part as claimed in claim 1, wherein the casting material of the mold is polymer with high release properties.

10. The method for manufacturing the mold for forming three-dimensional embossments on the surface of the shoe part as claimed in claim 2, wherein the casting material of the mold is polymer with high release properties.

11. The method for manufacturing the mold for forming three-dimensional embossments on the surface of the shoe part as claimed in claim 3, wherein the casting material of the mold is polymer with high release properties.

12. The method for manufacturing the mold for forming three-dimensional embossments on the surface of the shoe part as claimed in claim 4, wherein the casting material of the mold is polymer with high release properties.

13. The method for manufacturing the mold for forming three-dimensional embossments on the surface of the shoe part as claimed in claim 9 wherein the polymer with high release properties comprising polypropylenes, polyethylenes or polybutylene terephthalates.

14. The method for manufacturing the mold for forming three-dimensional embossments on the surface of the shoe part as claimed in claim 10 wherein the polymer with high release properties comprising polypropylenes, polyethylenes or polybutylene terephthalates.

15. The method for manufacturing the mold for forming three-dimensional embossments on the surface of the shoe part as claimed in claim 11 wherein the polymer with high release properties comprising polypropylenes, polyethylenes or polybutylene terephthalates.

16. The method for manufacturing the mold for forming three-dimensional embossments on the surface of the shoe part as claimed in claim 12 wherein the polymer with high release properties comprising polypropylenes, polyethylenes or polybutylene terephthalates.

17. The method for manufacturing the mold for forming three-dimensional embossments on the surface of the shoe part as claimed in claim 1, wherein the casting material is filled into the template, then vacuumed to form the mold, and the mold is separated from the template after cooling process, and a corresponding texture is formed at a position where the mold corresponds to the template with the texture structure.

18. A mold for forming three-dimensional embossments on a surface of a shoe part, comprising:
a mold body made by a template with a texture structure, the mold body includes at least one corresponding texture defined by the texture structure, the mold body is made by a two-component composition of silicones or polymers with high release properties.

19. The mold for forming three-dimensional embossments on the surface of the shoe part as claimed in claim 9, wherein the corresponding texture is a boundary wall, different regions being defined by each of the boundary walls respectively.
